(19) United States
(12) Patent Application Publication
(10) Pub. No.: US 2009/0010477 A1
(43) Pub. Date: Jan. 8, 2009

(54) LIGHTING AND SOUND REPRODUCTION

(75) Inventor: Paul Frobisher, Wiltshire (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Futuros Ltd., Corsham (GB)

(21) Appl. No.: 12/279,955

(22) PCT Filed: Mar. 20, 2007
(86) PCT No.: PCT/GB07/00985

§ 371 Date: Aug. 19, 2008

(30) Foreign Application Priority Data
Mar. 23, 2006 (GB) 0605824.2

(51) Int. Cl. H04R 1/02

(52) U.S. Cl. 381/386

(57) ABSTRACT

Sound reproduction and lighting apparatus, which is configured as a table lamp, comprises a light source (46) and a panel-form loudspeaker unit (40), at least a portion of which is transparent or translucent so that light from the light source passes therethrough in use. The light source (46) and panel-form loudspeaker unit (40) are mounted on a body (48) comprising a subwoofer enclosure (51) housing a subwoofer bass driver (50). The subwoofer enclosure (51) has an externally-mounted, tuned port (52) which supports the panel-form loudspeaker unit (40) behind a conventional lampshade (42). A reactive member may be situated between the light source (46) and the panel-form loudspeaker unit (40), the reactive member being configured to vary transmission of light passing therethrough (and hence through the panel-form loudspeaker unit) when exposed to vibrations.

### TECHNICAL FIELD

The invention relates to lighting and sound reproduction systems for household or commercial use, both indoors and outdoors.

It also relates to ‘flat-panel’ speaker technology which enables high-fidelity loudspeakers to be fabricated in virtually any size and shape, including curved or contoured designs. Further developments have included the ability to make these components transparent and are fabricated using various materials including glass and plastics. Developments in this field have primarily, but not exclusively, been developed by New Transducers Ltd and commercialised by NXT PLC. The technology is known as Distributed Mode (DM) technology and marketed as ‘Surface Sound’ and ‘Sound View’.

A sound reproduction system is a desirable feature to have in many rooms, residential or commercial. However, there are several drawbacks of sound systems, such as the necessary cables and the space required for system elements such as speakers. Many developments have taken place to improve the trade-off between having a sound system and accepting the accompanying drawbacks.

A necessary feature of most rooms is to have a lighting system. This invention makes it possible to integrate the necessary elements of a sound system into a lighting system, thereby obtaining an apparently invisible sound reproduction system. This is achieved without appreciable compromise to sound quality by suggesting the use, although not exclusively, of distributed mode loudspeaker (DML) technology.

Furthermore, the invention is able to provide interesting visual effects by using under-utilised resources without existing technologies, and also utilises effects considered harmful in some applications, by using them to interact with sound pressure waves, and in turn interact with light.

The invention also relates to various methods of changing light properties when it passes through various materials. The objective of some embodiments for the invention is to utilise sound pressure waves to modify light characteristics in a decorative and interesting way.

### BACKGROUND ART

It is known that the integration of sound production and light production is beneficial. For example, U.S. Pat. No. 5,980,057 describes a cone speaker arranged behind a light bulb.

It is known that a flat portion of material, when excited with a transducer, is able to produce sound and that this material can be transparent. This technology has been developed, although not exclusively, by New Transducers Ltd. U.S. Pat. No. 6,443,586 teaches that a flat panel speaker can be combined with a light source in order to illuminate an area in proximity to the speaker. EP 1 122 974A further teaches that it is beneficial to combine light and sound producing apparatus.

It is also known that a transparent speaker when placed in close proximity to an LCD display panel, for instance in a laptop computer, causes interference to the display at lower frequencies (typically <300 Hz). This effect needs to be managed in this application to minimise visual disturbance to the viewer.

In several of the embodiments of the invention, it is required to achieve high quality sound reproduction. The methods for optimising the sound quality are well-known, for instance in WO 97/09840. The reader is therefore referred to these and related teachings in order to optimise the sound reproduction quality of this present invention.

### SUMMARY OF THE INVENTION

A panel-form member, at least a proportion of which is transparent or translucent, when made to vibrate, varies the properties of light passing through it. This is referred to as the “reactive member”. The reactive member is placed adjacent to a vibrating surface, at least a proportion of which is transparent or translucent. Thus, interesting visual effects are created when the vibrating surface radiates sound pressure waves that create sympathetic vibrations within the reactive member.

The vibrating surface can be a well-known panel-form speaker. These are commercially available according to the known art previously mentioned. It can also be that of any vibrating surface of a musical instrument such as a guitar or violin.

The reactive member can, for instance, be made by utilising well-known technology in the fields of non-destructive testing of materials or optical fluid flow measurement. For example, a preferred method is to use the well-known phenomenon of stress refringence. This is achieved by laminating a film of photo-polarising material onto a low stiffness transparent plastic substrate. On the opposing surface of the substrate, a film of photo-elastic material is applied. A light source is situated such that light passes through the panel-form speaker and the resonant member, in line of sight of the viewer/listener. Thus, as the reactive member experiences resonant vibration, the properties of the light are altered.

Furthermore, the reactive member can be made to enclose fluids that react to sound pressure waves in a way that alters the properties of light. Such fluids can be gases, liquids, suspensions, emulsions, gels or plasma. For example, a well-known, commercially available, decorative plasma display can be made in panel form, and when excited by sound pressure waves emanating from a panel-form transparent speaker, interesting visual effects are observed.

The visual effects generated by the reactive member can be augmented by adding multiple light sources of varying colour, intensity and direction.

In a further aspect of the invention, an integrated light and sound reproduction system is constructed by mounting a panel-form speaker unit, at least a proportion of which is translucent or transparent, within a structure which also includes signal generation circuits, signal processing and amplification elements. This can include a reactive member as described above, or may have no reactive member. This may also include the integration of further subwoofer speaker elements into the unit to reproduce low frequency sound—typically below 150 Hz.

In a preferred embodiment, the essential working of a commonly known mini hi-fi system are integrated into the body of a table/desk lamp, together with a low frequency bass speaker (known as a subwoofer) arranged as a 4^{th} order band-pass with external, protruding tuned port. One or more flat panel speaker units, at least a proportion of which are translucent or transparent, are mounted onto the subwoofer port, adjacent to a commonly known light source within the unit. The speaker panels and light source are arranged such that the light passes through the panel-form speaker in line of sight of the viewer/listener. If this unit replaces an existing table/desk lamp then the function of sound reproduction is added to a room, without the apparent addition to a hi-fi system. This gives the benefit of improved utilisation of space.

According to one aspect of the present invention, there is provided sound reproduction and lighting apparatus, comprising: a light source and a panel-form loudspeaker unit comprising a sound-radiating panel at least a portion of which is transparent or translucent, the panel-form loudspeaker unit being mount relative to the light source such that, in use, at least some light from the light source passes through the transparent or translucent portion of the sound-radiating panel.

The apparatus may further comprise a body for housing sound reproduction components (e.g. an amplifier, audio signal components). The light source may be mounted on the body, and the panel-form loudspeaker unit may also be mounted on the body. In this way, an area around the body will be illuminated by light from the light source which has passed through the transparent or translucent portion of the sound radiating panel. Thus, light from the light source will be visible through the transparent or translucent portion of the sound-radiating panel, rather than be obscured by it.

The sound-radiating panel may define at least in part a shade for the light source, or it may be independent of a shade for the light source and disposed between the shade and the light source.

The body may define or comprise at least part of a loudspeaker enclosure housing at least one loudspeaker drive unit. For example, the body may be made of a rigid material which is itself suitable for the loudspeaker enclosure. Alternatively, the body may house a conventional loudspeaker enclosure and may be clad with a “soft” material which is unsuitable for a loudspeaker enclosure. The “soft” material serves merely as decorative, secondary packaging, and may be of basket-weave form.

The loudspeaker enclosure and the at least one loudspeaker drive unit may define a subwoofer to reproduce low-frequency sound, typically below 150 Hz.

The loudspeaker enclosure may be a compound or band-pass (4^{th} order) enclosure. Such an enclosure may comprise a first chamber and a second chamber with a dividing wall therebetween in which the at least one loudspeaker drive unit is mounted. The second chamber is “ported”, having an external, elongate and protuberant port, for example, extending away from the at least one loudspeaker drive unit.

The external port may act as a support shaft for mounting the panel-form loudspeaker and/or the light source on the base. The panel-form loudspeaker unit may be acoustically decoupled from the external port. For example, resilient padding may be disposed between the external port and the panel-form loudspeaker to prevent vibrations passing from one to the other.

When the loudspeaker enclosure is a compound or band-pass enclosure, at least part of a periphery of the second chamber may be transparent or translucent, and configured to allow light from the light source to pass therethrough. In this way, it may be possible to reduce the overall height of the apparatus (which may be configured as a table lamp), by reducing any spacing between the light source and the body, without the base casting an unacceptably large shadow.

The apparatus may further comprise a reactive component or arrangement which is configured to vary transmission of light passing therethrough when exposed to vibrations. The reactive component may be positioned relative to the light source and the panel-form loudspeaker to generate lighting effects in dependence upon vibrations in the sound-radiating panel when radiating sound. In this way, the apparatus may give rise to interesting visual effects.

The reactive component may be mounted on the transparent or translucent portion of the sound-radiating panel. For example, the reactive component may comprise a photo-elastic or photo-plastic material applied direct to one side of the transparent or translucent portion of the sound-radiating panel. A polarising film may be applied to an opposing side of the sound-radiating panel. In this way, light from the light source passes through the polarising film and the photo-elastic or photo-plastic material to produce a stress refringent pattern due to vibrations in the sound-radiating panel when radiating sound.

Alternatively, the reactive component may be spaced from the sound-radiating panel. For example, the reactive component may comprise a transparent or translucent member coated with at least one of a polarising film and a photo-elastic or photo-plastic material (as explained above). In another form, the reactive component may comprise a transparent or translucent member made from a photo-elastic material that is pre-prepared to set up stress fields within the member or on the surface thereof.

In yet another form, the reactive component may be constructed from a network of filaments, at least a proportion of which are constructed from or coated with a photo-reflective or photo-elastic material.

The network may work in the same way as a “monolithic” reactive component, with the network of filaments effectively being a fabric/cloth. In practice, the fibres would probably have to be packed close together to get them to vibrate. One benefit of this arrangement is that light will pass through the refringent material at a lot of different angles.

In still yet another form, the reactive component comprises a pair of spaced-apart transparent or translucent walls defining a chamber filled with at least one fluid which is configured to be disturbed by sound pressure waves generated by the sound-radiating panel. For example, the chamber may be filled with two immiscible liquids. Alternatively, the at least one fluid may be gaseous, and may be electrically excited to produce a plasma.

### BRIEF DESCRIPTION OF THE DRAWINGS

Embodiments of the invention, in its various aspects, will now be described by way of example and with reference to the accompanying drawings in which:

FIG. 1 is a cross-sectional view through a wall mounted speaker/light assembly with reactive member;

FIG. 2 is a front view of a reactive member using fibre-optic strands and secondary light sources;

FIG. 3 is a cross-sectional view of a resonant mode speaker panel with light reactive elements;

FIG. 4 is an isometric view of a reactive member with enclosed fluids;

FIG. 5 is a cross-sectional view of a fluid filled reactive member with internal protrusions;

FIG. 6 is an isometric sectional view through a wall-mounted modular light reactive speaker unit;

FIG. 7 is an isometric cross-sectional view through a guitar;

FIG. 8 is an isometric view of a guitar amplifier;

FIG. 9A is a cross-sectional view through a midi hi-fi table lamp;

FIGS. 9B and 9C are schematic sectional views through other midi hi-fi table lamp configurations;

FIG. 10 is a cross-sectional view through a midi hi-fi and table light combined into the structure of a table;

FIG. 11 is a cross-sectional view through a vehicle headlight with added sound reproduction capability;

FIG. 12 is a cross-sectional view through an integrated light/sound system interchangeable with existing light fitting;

FIG. 13 is a view of a building with “Tannoy”/public address system integrated with lighting system; and

FIG. 14 is an isometric view of a fluorescent tube with combined sound radiating function.

### DESCRIPTION OF EMBODIMENTS

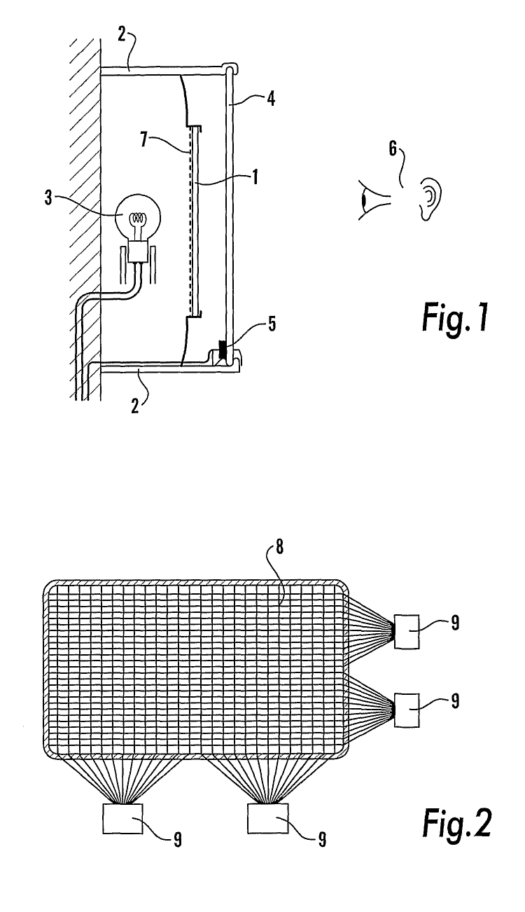

In FIG. 1, a reactive member (1) at least a proportion of which is transparent, is mounted within a framework (2) and placed between at least one primary light source (3), and at least one resonant mode speaker panel (4), at least a proportion of which is also transparent or translucent. The reactive member (1) is made to vibrate due to sound pressure waves generated from the speaker panel (4). The vibration cases the reactive member (1) to alter the properties of the light passing through it. The reactive member (1) can be placed between the viewer/listener (6) and the resonant speaker panel (4), or between the primary light source (3) and the resonant speaker panel (4). The resonant speaker panel is excited by at least one transducer (5) mounted suitably according to a well-known art. It is preferable for the reactive member (1) to be situated between the primary light source (3) and resonant speaker panel (4) as shown in FIG. 1, since in this way no interference with sound radiation can occur from the perspective of the viewer/listener (6).

The reactive member (1) is constructed from a material, or combination of materials, known to exhibit photo-elastic, or photo reflective properties, such as acrylic, polycarbonate or cyclic olefin polymer (COP) or the like, and composite materials thereof, in the form of fibre reinforcements, laminates, foams, honeycomb structures and the like. This requires the primary light source (3) to be of the appropriate type to produce this effect, such as polarised or laser light. Polarisation of the light is preferably, but not exclusively, achieved by coating the surface of the reactive member (1) facing the primary light source (3), with a commonly known membrane (7) which is photo polarising. In this way, light from the primary light source (3) passes through the polarising membrane (7) and then passes through the photo-elastic or photo-plastic material of the reactive member (1) which as it is being vibrated by the sound pressure waves, creates a moving stress refringent pattern.

Alternatively, the reactive member (1) may be made from photo-elastic material that is pre-prepared to set up stress fields within the body or surface of the material. In a preferred method, multiple fine holes, surface notches or any other pattern of geometric features that predispose the material to exhibit internal stress fields, are created in the structure of the reactive member (1), increasing the visual effect. Another possible method is to create internal stress fields by heat treatment. This occurs, for instance, when the substrate material is heat-treated tempered glass.

The reactive member (1) can also be constructed from a network of filaments such as a cloth or weave as shown in FIG. 2. At least a proportion of the filaments can be constructed from, or coated with, a photo reflective or photo-elastic material. The filaments can be fibre optic strands (8) and can be fed with light from a plurality of separate secondary light sources (9). This provides the benefit of adding additional colours and lighting effects.

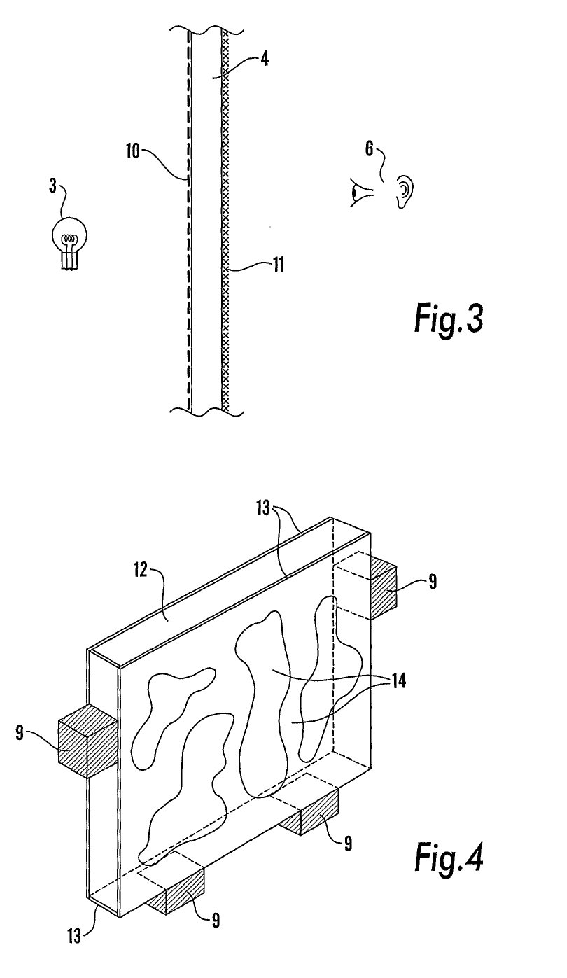

In another embodiment shown in FIG. 3, the resonant mode speaker panel (4), at least a proportion of which is transparent or translucent, is itself made to alter the properties of light passing through it, by means of materials that vary light-transmitting properties when exposed to vibration. This can be achieved, for instance, by using a photo-elastic or photo-plastic material applied directly to at least a portion of any surface of the resonant speaker panel member (4). In a preferred form, a polarising film (10) is bonded to the surface facing the light source (3) and a photo reflective or photo-plastic member (11) is bonded to the surface facing the viewer/listener (6). This aspect is beneficial in that a secondary reactive member is not necessary, saving cost, space and weight.

In another embodiment shown in FIG. 4, the reactive member (12), at least a proportion of which is constructed from transparent or translucent sheet members (13), encloses at least one fluid material (14) which is disturbed by the sound pressure waves generated by the speaker panel member (4). The fluid (14) can be a liquid or gas and can include materials in the form of gels or foams. The sound pressure waves disturb the fluid (14) so as to affect the light in a way visible to the viewer/listener (6). The fluid (14) is made to alter the properties of the light passing through it by interacting with a coating applied to any vibrating surface in close proximity to the fluid (14), for instance surfaces of members (13). The coating, or fluid (14) can be of materials that create electro static charges developed by piezo electric crystals or through magnetic fields, or by photoluminescence or acousto-optics effects, photochromic materials, piezochromic materials and the like.

In one form, the fluid materials enclosed within the reactive assembly (12) are selected to be insoluble, or immiscible with each other as with a well-known ‘Lava Lamp’, for example GB 2399446. The heat from the primary light source (3) is sufficient to generate heat to cause the slow moving effect of the fluids, which are selected to generate attractive colour displays. At least one additional secondary lighting source (9) can also be attached to the edge faces of the reactive member to increase the speed of movement of the fluids, and generate interesting effects. The device (9) can also be a heating element, without any lighting function. Additionally, the fluids (14) can be seeded with fluorescent or reflective elements, such as glass or polymer beads that are commercially available for measuring fluid flow. This further increases the decorative effect.

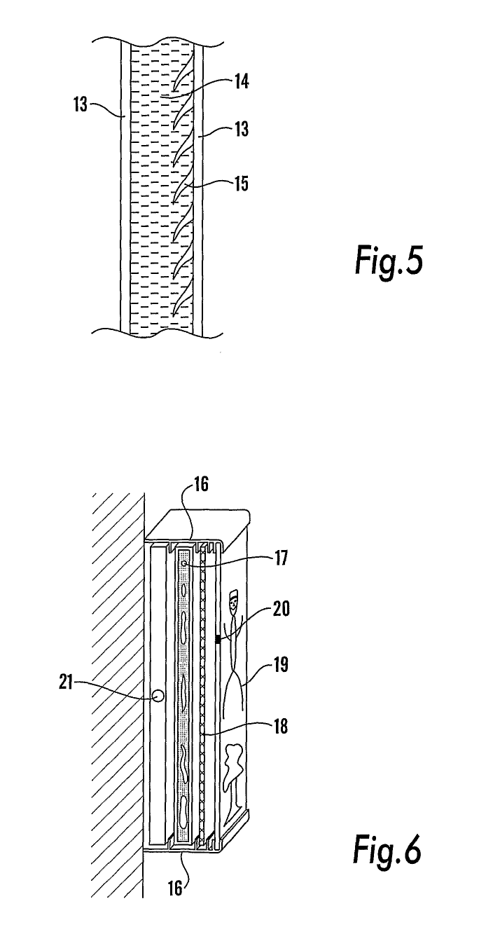

In a further arrangement shown in FIG. 5, the sheet members (13) described above include locally modified areas (15) that use the vibration imparted by the resonant panel (4) to act to move the fluid more rapidly than through heat convection alone. A preferred method to achieve this effect is to use a translucent or transparent resilient material that is able to be manufactured to provide undercut forms to act as miniature paddles (15) to disturb the fluid or fluids (14).

In a further arrangement, the fluid (14) contained within the sheet members (13) as described above is a gas, and a well-known commercially available device is used to create a fine mist or fog within the reactive member (12). This can be made in combination with the locally modified member described with reference to FIG. 5, enhancing the visual display.

In yet a further arrangement, the enclosed fluid (14) is a gas which is electrically excited to produce a plasma, using a well-known art. The plasma is affected by the sound waves by interacting with a transparent or translucent coating of piezo electric crystals applied to at least a portion of at least one of the surfaces of the enclosure (13). The disturbance of the crystals caused by the vibration imparted by the sound pressure waves creates fluctuations in electrical charges, which in turn cause the plasma to react in time with the sound pressure waves.

In a further arrangement shown in FIG. 6, a modular display unit is provided which allows different assemblies to be slotted into features within a frame (16) to allow the user to select various combinations of effects.

A user can select (in a back to front direction) a first module (17) as described with reference to FIG. 4, followed by a second module (18) incorporating a reactive member (1) as described with reference to FIGS. 1 and 2, followed by a third module incorporating a translucent image (19) such as a transparency or photograph, mounted directly to the transparent resonant speaker member (20). In the case of such an arrangement, in natural light, the viewer/listener (6) would see only the image (19). With the primary light source (21) energised, the viewer/listener (6) sees a coloured backlit image as the light travels through the first module (17). When the secondary lighting and/or heating elements (9) are activated for the first module (17), fluid movement modifies the colour of the image (19) as perceived by the viewer/listener (6). When the speaker member (20) is resonating sound, the sound pressure waves interact with the reactive member of the second module (18) and may also react with the first module (17) to change the appearance of the image (19), making it shimmer and/or change colour in time to the audio signal. The secondary lighting elements (9) can also be mounted to the side surface of the speaker member (20).

In one form, a commonly known circuit is provided to control the intensity and colour balance of at least one of the light sources in the assembly. In this way, the parameters set by the user are reflected in the lighting display in the speaker. For instance, as the volume is increased, the speaker may turn from blue to green to red, by balancing the intensity of the secondary light sources (9) or the primary light source (21). A preferred method of achieving this effect is to use a multiple array of coloured light sources and a network of fibre optic strands to carry the light to the periphery of at least one of the reactive elements are described with reference to FIG. 2. The visual impact is further enhanced by using a well-known electrical circuit to vary the lighting intensity of any of the light sources according to the audio or amplified signal characteristics.

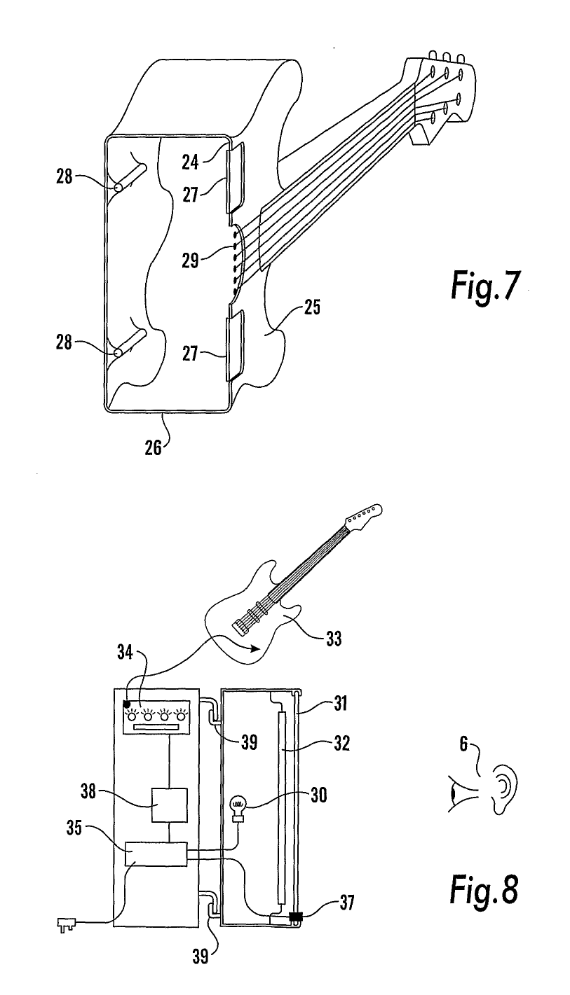

In an arrangement shown schematically in FIG. 7, a reactive member (1) as described with reference to FIG. 1 may be installed within a musical instrument, such as a guitar. At least one portion of the guitar body (24), preferably the top (25) or side surfaces (26) includes a transparent or translucent member (27). The transparent member (27) is made to vary its light transmitting properties when exposed to vibration, as described for the reactive member of FIG. 1. It is preferable for the transparent or translucent member (27) to be treated on at least a portion of at least one surface, with a photo-reflective material. At least one light source (28) is suitably mounted within the guitar body. As the guitar is strummed, the strings (29) cause resonance within the guitar body, and as the top surface vibrates the stress refringent effect is observed. In order to increase the display effect, any of the light sources can be controlled to vary the light intensity and colour with audio signal volume, as described in the preceding paragraph.

In a further arrangement shown schematically in FIG. 8, a light source (30) is directed to transmit light through a panel-form loudspeaker (31) at least a proportion of which is transparent or translucent, and a reactive member (32) of which at least a proportion is transparent or translucent, reacts to the sound pressure waves by modifying the characteristics of the light, as described above, in a sound reproduction device commonly known as an amplifier, usually for the purpose of amplifying the sound of a musical instrument or voice.

A conventional electric or electro-acoustic guitar (33) is connected to a commonly known modelling/effects unit (34), the output of which is fed to a stereo audio signal amplifier (35) which drives two panel-form loudspeakers (31), each having at least one transducer (37), which in this embodiment is edge mounted. A controller (38), integrated with a power amplifier (35), can be set to sense the input signal, either from the instrument (33) or from the effects/modelling unit (34) and vary the characteristics of the light in proportion to the signal characteristics. The two speaker panels are connected by means of a detachable hinge mechanism (39). The speaker panel units are equipped with a combination of at least one sound reactive member (32). The resulting amplifier is lighter in weight than a traditional guitar amplifier, and can be arranged such that the unit is collapsible, or foldable, to improve portability and storability. A further benefit is that the amplifier visually reacts to the playing of the musician. The guitarist and audience therefore experience greater interaction with the music. This is achieved without additional equipment or cabling in the performance area. Furthermore, the sound reproduction of the distributed mode speaker reduces the ‘hot spot’ effect common with traditional guitar amplification, providing a more even sound pressure level across the listening space.

The visual effects may be further enhanced by forming the reactive member (32) from a commonly known flat panel screen display as used with laptop computers and the like. This is driven to display any visual effect or display, which can in turn be modified according to the characteristics of the audio signal. For instance, the commonly known Windows Media Player software includes visual effects that react to audio signals. It is therefore preferred in this case that the controller (38) is a commonly known PC type computer able to run multimedia software and output to at least one flat panel display (40). This PC type computer would therefore also be available to run MIDI and other sound recording and playing software which would be an additional advantage to the user. It would therefore also be able to provide the function of the effects modelling unit (38). The invention could be used not only by the guitarist, but also as a P.A. system and visual display as desired by the user.

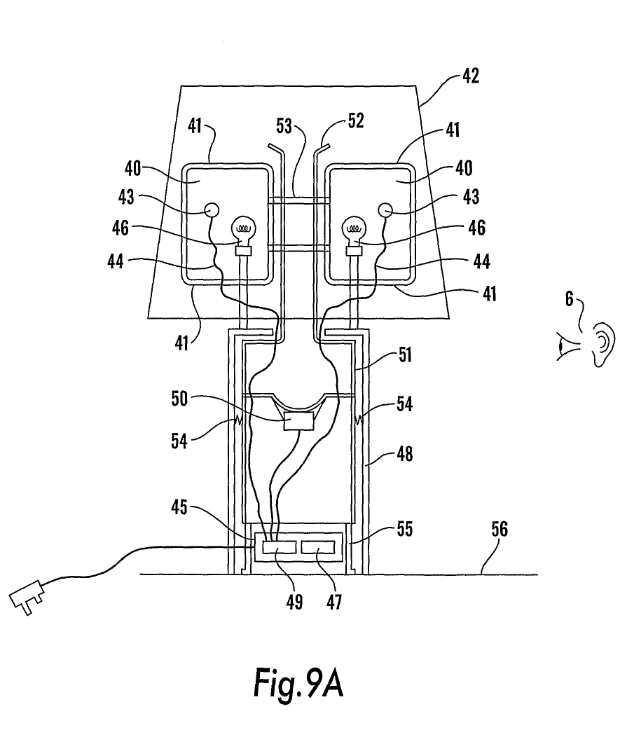

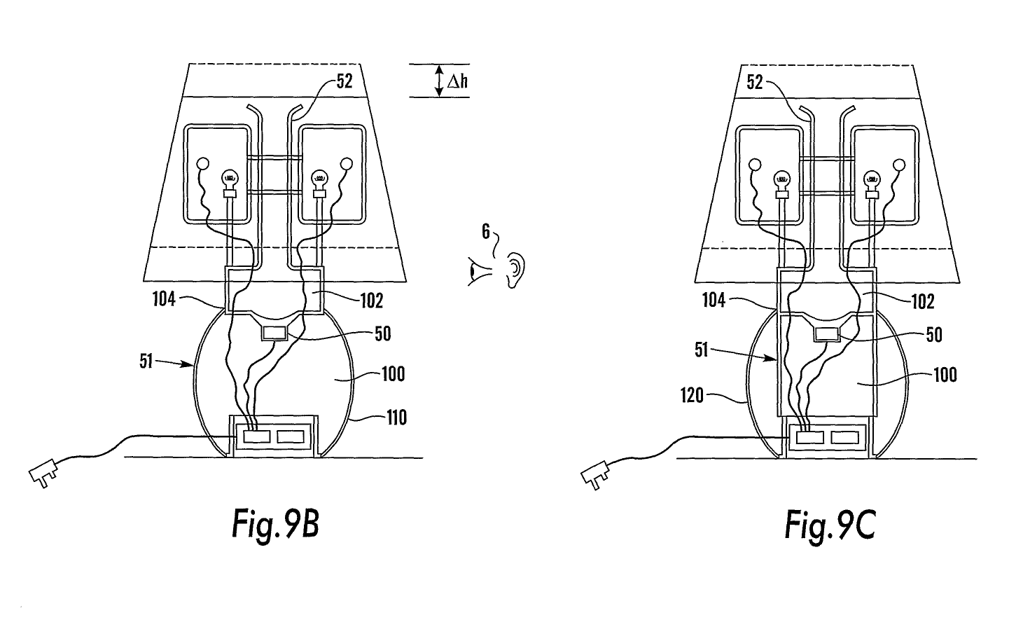

FIGS. 9A to 9C illustrate embodiments of the invention in which a table lamp or other such household lighting system is made to have the combined function of a typical mini hi-fi system and light. One or more, although preferably two, flat panel loudspeaker units (40), at least a proportion of which are transparent or translucent, are suitably mounted in a framework (41) behind a conventional lightshade or lampshade (42), constructed of a material with appropriate acoustic and lighting altering or reflective properties. The lampshade (42) should typically be made from a lightweight cloth-type material that is transparent to sound and is translucent to light. The speaker units (40) are driven by means of a transducer (43) fed by conductive cables (44) from an audio module (45) which is mounted within the body of the lamp (48). The speaker units (40) are intended to reproduce a well-known stereo audio sound image and are mounted such that they can be angled to produce the optimum sound performance as perceived by the viewer/listener (6) in the room environment.

A commonly available household light bulb assembly (46) is used to provide the primary light source, and is situated such that the speaker units (40) are between the light source (46) and the listener/viewer (6). the light sources (46) are mounted to the lamp base (48). The audio signal to be reproduced, such as speech or music is transmitted by means of a commonly known wireless radio system. The signal can be produced by any sound signal production system such as a well-known CD player, MP3 player or DVD player or radio system, and linked to a well-known radio transmitting device.

The resulting signal is detected by a radio receiver (47) mounted within the audio model (45) which delivers the signal to the input stage of a conventional power amplifier (49). The output stage of the power amplifier (49) drives the transducers (43) to drive the resonant panel speakers (40), preferably in stereo. In order to give full frequency response, the output stage of the power amplifier (49) also drives a subwoofer bass driver (50), mounted within a known subwoofer enclosure (51) within the body of the lamp (48). In a preferred arrangement, the type of subwoofer enclosure (51) is a 4^{th} order band-pass having an externally mounted tuned port (52) which exits through an aperture in the lamp casing (48). The speaker units (40) are mounted to the external port (52) using a framework (53) which gives the benefit of reduced parts count, improved aesthetics and improved utilisation of space whilst maintaining bass performance. An additional beneficial arrangement is that the subwoofer can be supported using compliant mounting such as elastomeric bearings (54) and also has supporting brackets (55) that make contact with the mounting surface (56). This preferred arrangement serves to isolate the audio module (45) from vibration emanating from the subwoofer enclosure (51) because the audio module is attached to the lamp base enclosure (48).

A reactive member (1) as described previously may be situated between the light source (46) and the speaker unit (4) in order to provide visual effects.

At least one audio source, such as a CD player, radio, MP3 player docking station can be included into the audio module (45) in addition to or replacing the wireless receive module (47).

FIGS. 9B and 9C illustrate schematically two variations of the table lamp of FIG. 9A. The subwoofer enclosure (51) has a first chamber (100) and a second chamber (102) which has the tuned port (52). The subwoofer bass driver (50) is mounted in a dividing wall (104) between the chambers, and faces towards the tuned port (52). In both FIGS. 9B and 9C, at least part of the enclosure (51) of the second chamber (102) is transparent and is elevated into the shade space (that is, the volume concealed by the shade), rather than sitting entirely below it. In this way, it is possible to reduce the apparent height of the lamp. FIG. 9B further illustrates an arrangement where the base (110) of the lamp defines the first chamber (100), and FIG. 9C further illustrates an arrangement where base (120) of the lamp includes part of the subwoofer enclosure (51), surrounded by secondary “packaging”, such as a decorative fabric, to conceal that part of the subwoofer enclosure from view.

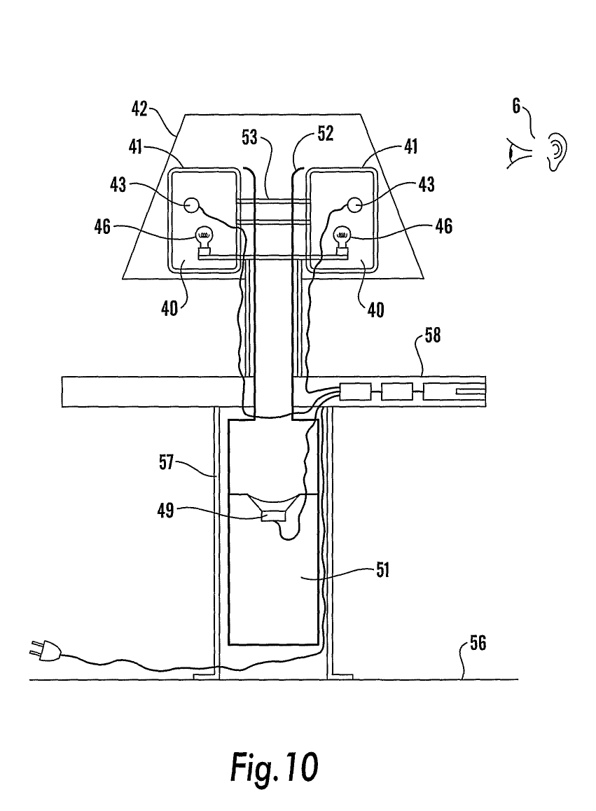

FIG. 10 illustrates a variant of the table lamp of FIGS. 9A-9C which has been integrated into furniture, such as a chair, table, desk or other such household, or office item. In a preferred embodiment, the subwoofer assembly (51) is mounted into casing structure (57) which would be commonly observed to be a table leg, which supports a horizontal member (58) which would be commonly observed as being a table top. The external subwoofer port (52) protrudes vertically through the horizontal member (58) and supports the light sources (46), resonant mode speaker panels (40), lampshade (42) in the same way as described before. In this way, the lampshade base can be effectively hidden from the viewer/listener (6), further improving utilisation of space.

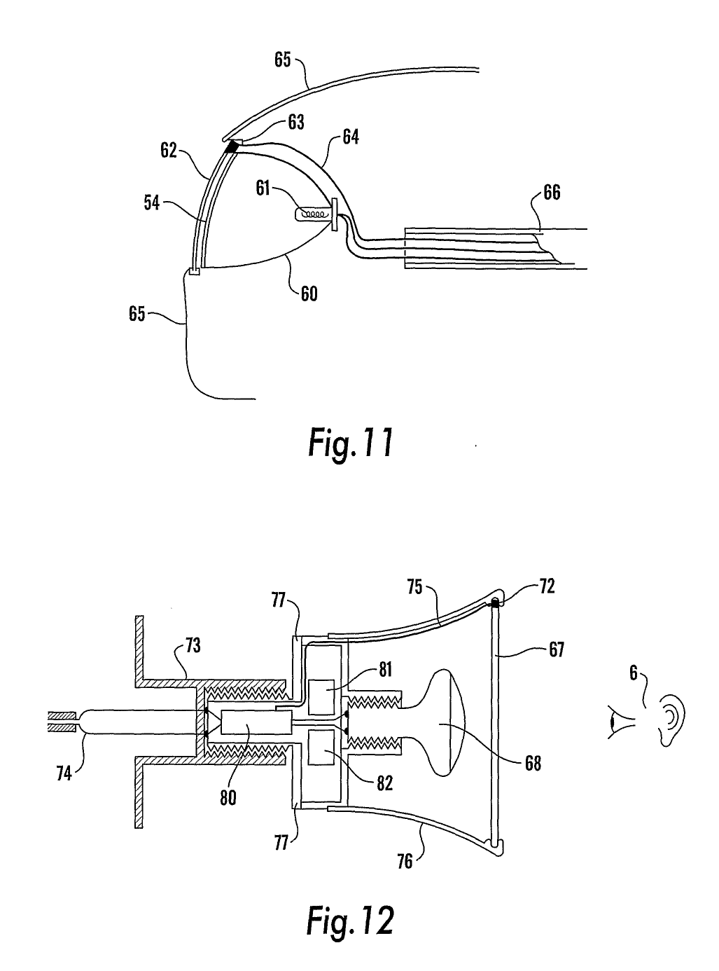

FIG. 11 illustrates schematically a typical motor vehicle with a conventional external lighting unit, such as a headlight, fog light or reversing light comprising a lens (59), fixed to a reflector (60), which acts to guide light from a light source, typically a conventional bulb (61) in order to illuminate an area directly in the vicinity of the vehicle. At least one resonant mode panel speaker (62), at least a portion of which is transparent or translucent, is incorporated within, or suitably mounted in close proximity to at least one external lighting device of a moving vehicle. The speaker is driven by at least one transducer (63) mounted on the periphery of the panel (62) fed by a cable (64). It is preferred that the transducer is hidden from view by the bodywork (65). It is preferential, but not necessary, to feed the panel loudspeaker in the same wiring harness (66) as the cables to the light bulb (61).

The arrangement described with reference to FIG. 11 allows the transmission of sound by a vehicle, such as a horn sound, through its lighting system. This removes the need for a separate horn assembly, saving packaging space and weight. As the headlamps are already supplied with electrical power, cabling is reduced, saving weight and cost. The arrangement also acts as an impact barrier, protecting the glass lens (59) from impact damage from debris, such as stones. Many motor vehicles are already fitted with transparent stone chip protectors. Therefore, by merging the function of the horn with the stone chip protectors, the overall parts count of the vehicle is reduced. It is well-known that a resonant mode speaker (62) can maintain its function when it has received damage to its surface, and so is suitable for use in this environment. Furthermore, a drawback of existing horns is that they are mono. This makes it difficult for pedestrians to hear the direction from where the sound is coming from. It is preferred that both front headlights or other lights on a moving vehicle such as a passenger vehicle, are fitted with the sound/light arrangement such that the sound can be generated in stereo, enabling the person hearing the horn sound, to better detect the direction of the sound, thereby improving road safety. It is also an embodiment of the invention that the vehicle driver can select a particular horn sound from a pre-selected list, which adds to the ability of the car user to customise the vehicle to their taste. It also enables the user to play music externally from the vehicle.

FIG. 12 illustrates schematically an assembly comprising a resonant speaker panel (67) at least a proportion of which is transparent or translucent, and a light source (68). The assembly is fabricated to fit to an existing lighting system in place of an existing light source which could be, for instance, bayonet fixing or screw fixing or fixing for a fluorescent tube, or other such device. The speaker panel (67) is mounted between the light source (68) and the viewer/listener (6). It is preferential for the assembly to include a signal receiver (69), control unit (70) and amplifier (71) in order to process the audio signal and drive the resonant speaker panel (67) by means of a transducer (72).

A typical household electrical light fitting (73) is powered by mains lighting circuit conductors (74). The light fitting body is shown as a screw type but could equally be of the bayonet or any other type. The assembly is screwed into the light fitting (73) as would a standard light bulb. The panel-form loudspeaker (67) is driven by at least one edge type transducer (72) by means of a conductor (75). A light reflective member (76) is provided to direct the light from the light source (68) towards the viewer/listener (6). The reflective member (76) is clipped onto the main housing of the light/sound assembly in such a way that it can be removed to allow access to maintain or replace the light source (68). The main housing (77) which is preferred to be made from a non-conductive plastic moulding, provides the screw thread which secures the assembly into the light fitting body (73).

Electrical signals are passed to the panel transducer (72) by means of a conductor (79) fed by a power amplifier (80) which also feeds electrical current to the light source (68). A signal processor (81) provides the signal to be amplified by means of a conductor (not shown for clarity in FIG. 12) to the input side of the amplifier (80). The signal processor (81) contains a radio receiving circuit to pick up radio waves from a remote radio signal transmitter at the appropriate frequency, which is a commonly understood technology. The signal can therefore be speech, music or other sounds or sound effects. A controller (82) is provided in order to control the parameters of the amplifier unit (80) to switch, or dim the light (68) or alter the volume, bass and treble of the sound. In this invention, the control unit (82) is controlled by radio frequency. This embodiment gives the benefit that sound can be provided in a room or outdoor area without the need to take up any space other than that already used within an existing lighting fixture. This can be achieved with any light fitting that has sufficient space to accommodate the light/sound assembly.

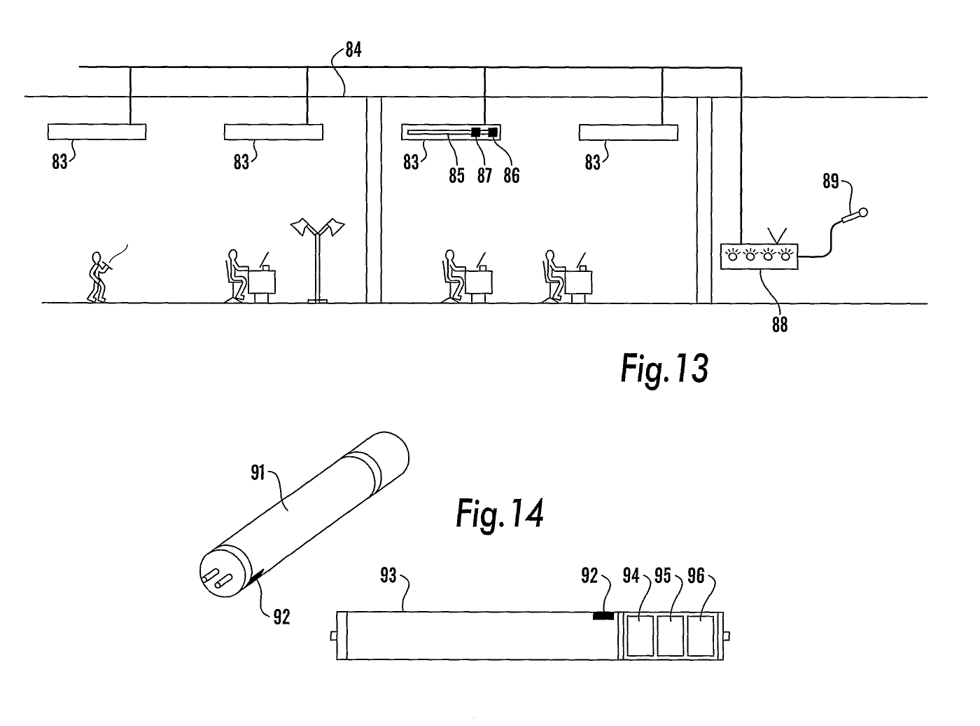

FIG. 13 illustrates that the assembly of FIG. 12 may be used in a plurality of discrete units to form an array of sound emitting lighting units (83) throughout a building (84) or area. Alternatively, each light source (85) may be configured as a fluorescent tube (see below). Each unit (83) is controlled by a unit controller (86) which adjusts the sound qualities of bass, treble, volume and the like. A unit signal processor (87) is in communication with a central controller (88) which communicates control information of volume, bass, treble and the like to each unit (83). The unit controller (86) is given a unique reference identity by a central control unit (88). The controller is then able to ‘zone’ so that sound, such as an announcement or alarm, is only transmitted to a designated area or areas of the building, and each unit, by virtue of its unique reference identity. The audio signal to be amplified and transmitted is fed to the unit by wireless means or by superimposing a signal onto the mains supply. The controller is also able to control the light level. This therefore allows the central controller to manage sound and lighting. The audio signal to be transmitted can be any audio signal generating device such as a computer, MP3 player and the like, but is also preferably to be through a microphone (89). This enables a person to make announcements to any combination of zones throughout the building. A further preferred method of carrying out the invention is that individual areas or rooms are provided with microphones (90) in order for a person to be able to receive sound support whilst, for instance, talking to a large group of people within a room or area. A particular application for this invention is in school classrooms.

According to the teaching of GB 2370939 a DSM acoustic radiator can be cylindrical. In FIG. 14, the cylindrical surface of a well-known fluorescent light tube assembly (91) itself becomes an acoustic radiator, by means of an exciter transducer (92) mounted to the translucent tube cylinder (93) connected to an amplifier (94) which is fed a signal by a signal processor (95) which is preferred to be a radio receiver. The operating parameters of the sound produced such as volume, bass, treble and the like are set by the controller (96) as described above.

By providing a package space within the standard enclosed volume usually occupied by a standard fluorescent light fitting, the installation of a public address or system as described above may be simplified further, such that the system can be installed within a building as easily as replacing a number of fluorescent tubes.

1-16. (canceled)

17. Sound reproduction and lighting apparatus, comprising:
a body for housing sound reproduction components, the body forming at least part of a loudspeaker enclosure housing at least one loudspeaker drive unit to define a subwoofer to reproduce low-frequency sound;
a light source; and
a panel-form loudspeaker unit comprising a sound-radiating panel at least a portion of which is transparent or translucent, the panel-form loudspeaker unit being mounted relative to the light source such that, in use, at least some light from the light source passes through the transparent or translucent portion of the sound-radiating panel, wherein the loudspeaker enclosure is a compound or band-pass (4th order) enclosure.

18. Apparatus according to claim 17, in which the light source is mounted on the body, and in which the panel-form loudspeaker unit is mounted on the body.

19. Apparatus according to claim 17, in which the sound-radiating panel defines at least in part a shade for the light source.

20. Apparatus according to claim 17, in which the enclosure comprises a first chamber and a second chamber with a dividing wall therebetween in which the at least one loudspeaker drive unit is mounted, with the second chamber having an external, elongate and protuberant port.

21. Apparatus according to claim 20, in which the external port acts as a support shaft for mounting the panel-form loudspeaker on the body.

22. Apparatus according to claim 20, in which at least part of a periphery of the second chamber is transparent or translucent, and configured to allow light from the light source to pass therethrough.

23. Apparatus according to claim 17, further comprising a reactive component which is configured to vary transmission of light passing therethrough when exposed to vibrations.

24. Apparatus according to claim 23, in which the reactive component is positioned relative to the light source and the panel-form loudspeaker to generate lighting effects in dependence upon vibrations in the sound-radiating panel when radiating sound.

25. Apparatus according to claim 23, in which the reactive component may be mounted on the transparent or translucent portion of the sound-radiating panel.

26. Apparatus according to claim 23, in which the reactive component is spaced from the sound-radiating panel.

27. Apparatus according to claim 26, in which the reactive component is constructed from a network of filaments, at least a proportion of which are constructed from or coated with a photo-reflective or photo-elastic material.

28. Apparatus according to claim 26, in which the reactive component comprises a pair of spaced-apart transparent or translucent walls defining a chamber filled with at least one fluid which is configured to be disturbed by sound pressure waves generated by the sound-radiating panel.
